(19) United States
(12) Patent Application Publication
(10) Pub. No.: US 2013/0246917 A1
(43) Pub. Date: Sep. 19, 2013

(54) Virtual Representation of a Media Product

(71) Applicant: Andrew Neil Carne, Essex (GB)

(72) Inventor: Andrew Neil Carne, Essex (GB)

(21) Appl. No.: 13/635,308

(22) PCT Filed: Mar. 16, 2011
(86) PCT No.: PCT/GB11/50522

§ 371 Date: May 20, 2013

Related U.S. Application Data
(60) Provisional application No. 61/314,793, filed on Mar. 17, 2010.

(51) Int. Cl. G06F 3/16

(52) U.S. Cl. CPC G06F 3/16
USPC 715/716

(57) ABSTRACT

A method of providing access to media content and a virtual representation of physical packaging associated with said media content. The method includes providing, on a display of a computing device, a virtual representation of a physical media package, said virtual representation comprising at least one dynamically-rendered three-dimensional object. The method also includes providing, on the computing device, navigational controls to enable a user to dynamically manipulate said virtual representation and providing, on the computing device, media controls to enable said user to select said media content associated with said physical media package.

### RELATED APPLICATIONS

This application is the U.S. National Stage under 35 U.S.C. §371 of and claims priority to International Patent Application No. PCT/GB2011/050522 filed Mar. 16, 2011, entitled “Virtual Representation of a Media Product,” which claims the benefit of U.S. application Ser. No. 61/314,793 filed Mar. 17, 2010, both of which are incorporated herein by reference in their entireties for all purposes.

### STATEMENT REGARDING FEDERALLY SPONSORED RESEARCH OR DEVELOPMENT

Not applicable.

### BACKGROUND

Increasingly, downloading or streaming of media content online is becoming the preferred method for obtaining media content such as audio tracks and video. Media is obtained from a remote source (such as a media server) through a network such as the Internet or an Ethernet. The media may be obtained in a number of ways; for example, on a pay per view/listen format in which media is streamed from a remote source (such as a networked server). Alternatively, a track may be purchased on line, downloaded and then stored locally on a client computing device (such as a PC or music player). A further variation may be a hybrid of both of the above in which the media content is downloaded to the client computing device but expires or becomes unusable after a set period of time or number of playbacks.

There are numerous advantages to online media purchase or consumption; for example, ease of use, accessibility and cost. The lower overheads offered through the lack of need to provide media content packaging, distribution networks and purchase centres are attractive to businesses. Additionally, these reduced costs are often reflected in the lower cost of the media content itself when purchased online.

However, a disadvantage of online digital media when compared to a traditional compact disc (CD) is that only the media content (e.g., audio tracks or video files) itself is available for purchase.

### SUMMARY

The present disclosure relates to a method of, and a computing device for, providing access to media content and a virtual representation of the physical packaging of the media content.

According to a first aspect of the present disclosure, there is provided a method of providing access to media content and a virtual representation of physical packaging associated with said media content. The method includes providing, on a display of a computing device, a virtual representation of a physical media package, the virtual representation comprising at least one dynamically-rendered three-dimensional object. The method also includes providing, on the computing device, navigational controls to enable a user to dynamically manipulate said virtual representation and providing, on the computing device, media controls to enable said user to select said media content associated with said physical media package.

By providing such a method, the whole packaging accompanying media content such as an audio product can be digitally represented for the consumer. By associating navigation controls with the object, the consumer is able to view, for example, the compact disc (CD) box artwork on all sides and from any angle as if they had a physical copy of the CD box in their hands.

Further, by providing a dynamically-rendered three-dimensional object (i.e., a three-dimensional model generated on the fly) the user experience is improved because the model is scalable and can be rotated or translated seamlessly without loss of image quality. In contrast, most known examples of three-dimensional representations of products comprise pre-produced still images which are rapidly changed in sequence to simulate rotation or movement of the product. Such images are size-inefficient and are not true representations of the product. Often, they are not of high enough resolution to accurately convey the detail of the product and cannot be viewed close up (“zoomed”) without loss of detail and quality.

In one embodiment, the navigational controls enable the virtual representation to be rotated or translated in at least one dimension.

In another embodiment, the virtual representation comprises packaging objects and content-specific objects.

In one variation, the packaging objects are common for each virtual representation of a physical media package and the content-specific objects are specific to each virtual representation of a physical media package. By utilizing such an approach, a standard packaging object can be created to which content-specific media can be associated. This reduces the amount of computational resources and storage capacity required.

In one version, the packaging objects comprise a three-dimensional virtual representation of a CD case.

In one embodiment, the content-specific objects comprise front and back cover graphics of the physical media package.

In another embodiment, the content-specific objects comprise an inlay booklet. By providing such a method, the consumer may be able to view additional objects, such as an inlay card, which may have descriptions of the album, of tracks, or which may contain lyrics or other comments from the artist.

In a variation, the media controls are associated with the inlay booklet.

In a further variation, the media controls comprise media links to audio tracks comprising the media content. By associating media controls with the objects, the user may, for example, choose to play audio tracks by selecting them from the inlay card.

In one version, said media controls further comprise audio functions to enable a user to play the audio tracks.

In another version, the media links comprise links to enable a user to stream the media content to the computing device from a media store or to download the media content to the computing device from a media store.

In one embodiment, the media links comprise links to enable a user to purchase the media content from a media store.

In another embodiment, the method further comprises providing the inlay booklet with a plurality of pages, each page comprising a page image.

In one embodiment, each page image comprises a first page image having a first resolution and a second page image having a second, higher resolution.

In a further embodiment, the method further comprises loading and displaying each first page image while the second page image is being loaded.

According to a second aspect of the present disclosure, there is provided a computing device for providing access to media content and a virtual representation of physical packaging associated with the media content. The computing device includes a display and is operable to provide, on the display, a virtual representation of a physical media package, the virtual representation comprising at least one dynamically-rendered three-dimensional object. The computing device is further operable to provide navigational controls to enable a user to dynamically manipulate the virtual representation and provide media controls to enable the user to select the media content associated with the physical media package.

By providing such a computing device, the whole packaging accompanying media content such as an audio product can be digitally represented for the consumer. By associating navigation controls with the object, the consumer is able to view, for example, the CD box artwork on all sides and from any angle as if they had a physical copy of the CD box in their hands.

In one embodiment, the navigational controls enable the virtual representation to be rotated or translated in at least one dimension.

In one embodiment, the virtual representation comprises packaging objects and content-specific objects.

In one embodiment, the packaging objects are common for each virtual representation of a physical media package and the content-specific objects are specific to each virtual representation of a physical media package.

In one embodiment, the packaging objects comprise a three-dimensional digital representation of a CD case.

In one embodiment, the content-specific objects comprise a front and back cover graphics of the physical media package.

In one embodiment, the content-specific objects comprise an inlay booklet.

In one embodiment, the media controls are associated with the inlay booklet. By providing such a computing device, the consumer may be able to view additional objects, such as an inlay card which may have descriptions of the album, of tracks, or which may contain lyrics or other comments from the artist.

In one embodiment, the media controls comprise media links to audio tracks comprising the media content.

In one embodiment, the media controls further comprise audio functions to enable a user to play the audio tracks.

In one embodiment, the media links comprise links to enable a user to stream the media content to the computing device from a media store or to download the media content to the computing device from a media store.

In one embodiment, the media links comprise links to enable a user to purchase the media content from a media store.

In one embodiment, the computing device is further operable to provide the inlay booklet with a plurality of pages, each page comprising a page image.

In one embodiment, each page image comprises a first page image having a first resolution and a second page image having a second, higher resolution.

In one embodiment, the computing device is further operable to load and display each first page image while the second page image is being loaded.

According to a third aspect of the present disclosure, there is provided a computer program product executable by a programmable processing apparatus, comprising one or more software portions for performing the method of the first aspect.

According to a fourth aspect of the present disclosure, there is provided a computer usable storage medium having a computer program product according to the third aspect stored thereon.

According to a fifth aspect of the present disclosure, there is provided a graphical user interface generated by an application program operating on a computing device and operable to provide access to media content and a virtual representation of physical packaging associated with the media content. The graphical user interface is operable to display a virtual representation of a physical media package as at least one dynamically-rendered three- dimensional object, to provide navigational controls to enable a user to dynamically manipulate the virtual representation, and to provide media controls to enable the user to select media content associated with the physical media package.

In one embodiment, the graphical user interface further comprises an application window, the virtual representation being displayed within the application window.

In one embodiment, the application program is run locally on the computing device.

According to a sixth aspect of the present disclosure, there is provided a method of providing access to a media store comprising a virtual representation of physical packaging associated with media content. The method includes providing, on a display of a computing device, a virtual representation of the physical packaging associated with specific media content, the virtual representation comprising at least one dynamically-rendered three-dimensional object. The method further includes providing, on the computing device, navigational controls to enable a user to dynamically manipulate the virtual representation.

By providing such an arrangement, media content within a media store (which may be, for example, an online purchasing environment, a website of a music band, or a local hard disk drive comprising stored media content) can have additional content associated therewith. In this example, the additional content comprises a virtual representation of the physical packaging associated with the media content, enabling the user to view the whole packaging accompanying media content such as an audio product. Further, by associating navigation controls with the object, the consumer is able to view, for example, a representation of the physical packing on all sides and from any angle as if they had a physical copy of the packaging (which may, for example, comprise a CD or DVD box) in their hands.

In one embodiment, the physical packaging comprises a CD case and the specific media content comprises audio tracks.

In one embodiment, the physical packaging further comprises front and back cover artwork and/or an inlay booklet.

In a variation, the media store comprises a networked media store or a storage resource local to the computing device.

According to a seventh aspect of the present disclosure, there is provided a computing device for providing access to a media store comprising a virtual representation of physical packaging associated with the media content. The computing device comprising a display and is operable to provide, on the display, a virtual representation of the physical packaging associated with specific media content, the virtual representation comprising at least one dynamically- rendered three-dimensional object. The computing device is further operable to provide navigational controls to enable a user to dynamically manipulate the virtual representation.

In one arrangement, the physical packaging comprises a CD case and the specific media content comprises audio tracks.

In another arrangement, the physical packaging further comprises front and back cover artwork and/or an inlay booklet.

In one embodiment, the media store comprises a networked media store or a storage resource local to the computing device.

According to an eighth aspect of the present disclosure, there is provided a graphical user interface generated by an application program operating on a computing device and operable to provide access to a media store comprising a virtual representation of physical packaging associated with media content. The graphical user interface is operable to display a virtual representation of physical packaging associated with specific media content as at least one dynamically-rendered three-dimensional object and to provide navigational controls to enable a user to dynamically manipulate the virtual representation.

According to a ninth aspect of the present disclosure, there is provided a method of providing access to media content and a virtual representation of physical packaging associated with the media content. The method includes providing one or more virtual representations of physical media packages according to the first aspect arranged as a content library and providing controls to enable a user to select one or more of the virtual representations from the content library.

In an embodiment, the method further comprises providing, on the computing device, navigational controls to enable a user to dynamically manipulate the content library.

According to a tenth aspect of the present disclosure, there is provided a graphical user interface generated by an application program operating on a computing device and operable to provide access to a content library comprising one or more virtual representations of physical packaging associated with media content according to the eighth aspect. The graphical user interface is operable to provide controls to enable a user to select one or more of the virtual representations from the content library.

In an embodiment, the graphical user interface comprises navigational controls to enable a user to dynamically manipulate the content library.

According to an eleventh aspect of the present disclosure, there is provided a computing device for providing access to media content and a virtual representation of physical packaging associated with the media content. The computing device includes a display and is operable to provide, on the display, a virtual representation of a content library comprising one or more virtual representations of physical packaging associated with media content according to the second aspect and to provide controls operable to enable a user to select one or more of the virtual representations.

In an embodiment, the computing device is operable to provide navigational controls to enable a user to dynamically manipulate the content library.

According to a twelfth aspect of the present disclosure, there is provided a computer program product executable by a programmable processing apparatus, comprising one or more software portions for performing the method of the ninth to eleventh aspects.

According to a thirteenth aspect of the present disclosure, there is provided a computer usable storage medium having a computer program product according to the twelfth aspect stored thereon.

In the description and appended claims, it is herein contemplated that any of the features of the method claims could be incorporated into the computer device and/or graphical user interface claims.

### BRIEF DESCRIPTION OF THE DRAWINGS

Embodiments of the present disclosure will now be described in detail with reference to the accompanying drawings, in which:

FIG. 1 is a schematic diagram of a networked store;

FIG. 2 is a schematic diagram showing the components of an application program according to an embodiment of the disclosure;

FIG. 3 is a view of a graphical user interface presented to a user of the application program;

FIG. 4 is an alternative view of the graphical user interface presented to a user of the application program;

FIG. 5 is an alternative view of the graphical user interface presented to a user of the application program showing an inlay booklet;

FIG. 6 is an alternative view of the graphical user interface presented to a user of the application program showing a sign-up sheet;

FIG. 7 is a schematic flow diagram of the process for representing an inlay booklet as shown in FIG. 5 on the graphical user interface; and

FIG. 8 is a view of a graphical user interface presented to a user of the application program showing a storage selection screen for a plurality of virtual media.

### DETAILED DESCRIPTION

In some cases, an online media purchase may also include, for example, a low- resolution graphic of the cover of a music album. However, peripheral media information (such as track-listings, lyrics, artwork and inlay booklets) which accompanies a compact disc (CD) is not available to the online consumer.

Therefore, since the complete artwork and inlay booklet are not available to the online purchaser, additional content originally intended by the author of the work to accompany the media content cannot be experienced by the consumer. As a result, many consumers prefer to purchase a CD so that they can obtain the additional content provided with a physical CD in order to enhance their media experience.

Therefore, to date, known online media distribution and consumption arrangements have suffered from a technical problem that associated media content cannot be distributed to the consumer together with the media content itself. Consequently, there is a need to provide equivalent functionality to physical media in the online retail environment.

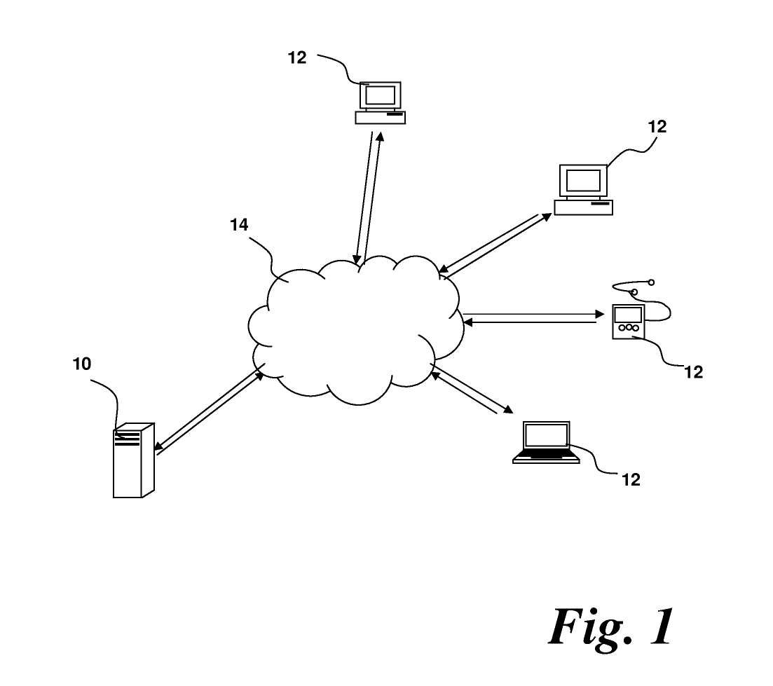

FIG. 1 shows a schematic illustration of an environment in which the present disclosure may be used. An electronic media store 10 is provided by a service provider. The media store 10 may comprise a plurality of servers and a storage resource comprising a plurality of hard disk drives (HDDs) linked together through a protocol such as Redundant Array of Inexpensive Disks (RAID) to form a logical unit. Alternatively, other suitable protocols may be used. However, irrespective of the number or configuration of HDDs present, the media store 10 is presented to a client computer as a single data store.

The media store 10 comprises various software and hardware applications. The media store 10 may comprise a database server for managing content on the media store 10, a web server to provide internet access and to enable client computers 12 to connect thereto, and a media management server operable to enable streaming of audio and video content or downloading thereof.

Alternatively, the media store 10 may comprise a local computer in, for example, a networked domestic environment. The media store 10 may comprise a personal computer (PC) in which media content is stored on a local hard disk drive or other storage resource.

A plurality of client computing devices 12 connect to the media store 10 through a network 14. The computing devices 12 may take any suitable form; for example, they may comprise PCs running an operating system such as Microsoft Windows™, MacOS™, Android™ or Linux. It will be appreciated by the skilled person that the PCs may take any appropriate form; non-limiting examples may include laptops, desktops, towers, tablets or netbooks. Alternatively, the computing devices may take the form of portable computing devices such as mobile phones, smartphones or MP3 players. Other forms of computing device may also be used which fall within the scope of the present application.

Each computing device 12 comprises some form of display upon which information can be displayed to the user. In the case of a personal computer, this may be in the form of a monitor (such as an LCD or CRT screen) or a projector. For a mobile phone, smartphone or MP3 player, the display may be in the form of an LCD or OLED display screen. The above are to be taken as non-limiting examples and other variations of display may be utilized.

Additionally, the network 14 may be omitted and the media store 10 may comprise a hard disk drive, solid state drive or other storage resource local to the computing device 12. Media content stored on the local media store 10 can then be accessed as required by the computing device 12.

If provided, the network 14 may take a number of forms, for example, an internet network, a cable network, a mobile network, a local area network (LAN), a wide area network (WAN) or Ethernet. The network 14 enables each user of each client computer 12 to access the media store 10 to, for example, download or to stream media content as required.

Each client computer 12 comprises a display capable of displaying a graphical user interface (GUI) forming part of an application program.

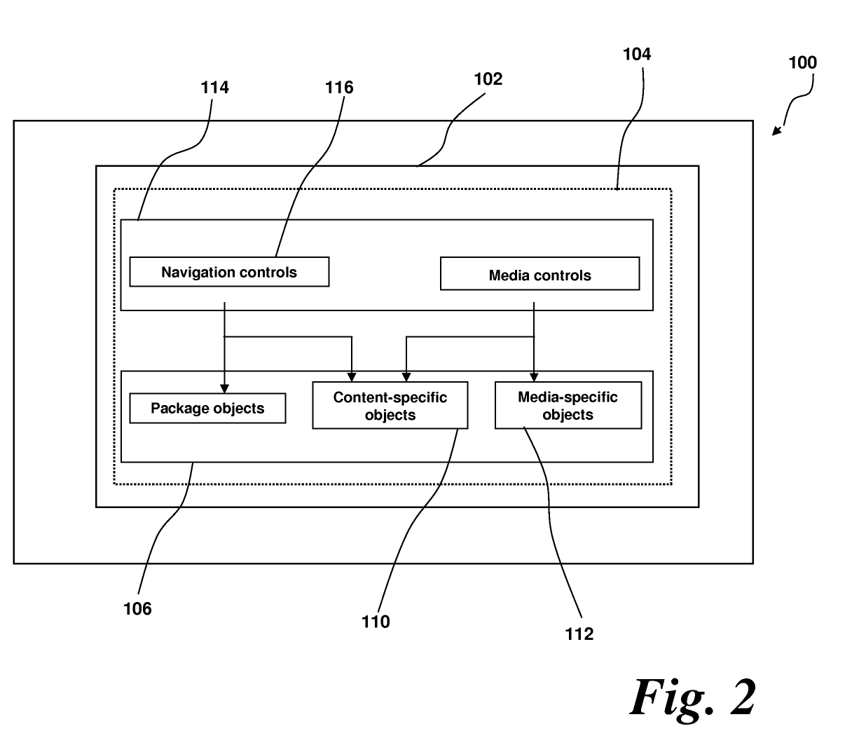

FIG. 2 shows an example of an application program 100. The application program 100 is either run locally on the client computing device 12 or is run remotely on the media store 10. The application program 100 may comprise a standalone program or interface, or may form part of another application; for example, an internet browser application. In the latter case, the application program 100 may comprise an add-on program commonly referred to as a “plug-in.” A commonly used plug-in is Adobe™ Flash. Plug-ins enable content or application specific programs to be run on the internet browser application; for example, to display an interface to access the media store 10. Alternatively, the application program 100 may comprise a standalone program on a computing device such as a smartphone. Such a program is often referred to as an “app.”

The application program 100 comprises a graphical user interface (GUI) 102. The GUI 100 provides a visual interface by means of which the user is able to access the media content on the media store 10. The GUI 102 may be run in, for example, an application window 104 on the display of a computing device. The application window 104 is a defined area on the GUI 102 in which graphics and media content can be presented to the user.

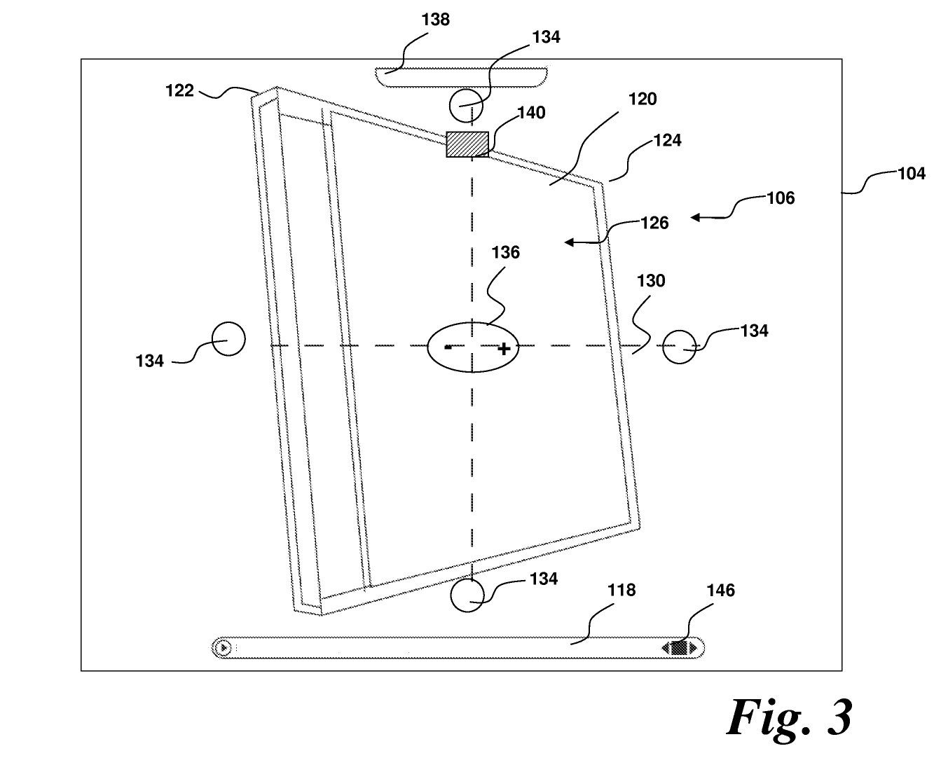

Within the application window 104, a physical media package such as a CD case is represented by a virtual media package 106. The virtual media package 106 is a virtual representation of a physical, real-world CD box in a virtual space. The virtual media package 106 comprises a dynamically-rendered and interactive, 3-dimensional (3D) graphical representation of a CD package and associated content. FIG. 3 shows a still image of the virtual media package 106 in an application window 104. The components of the virtual media package 106 will be described later.

The virtual media package 106 comprises a number of objects. The objects are divided into different classes: package objects 108, content-specific objects 110 and media-specific objects 112. All of the objects 108, 110, 112 are individually and dynamically positioned in the virtual 3D space of the application window 104.

The application program 100 further comprises a control block 114. The control block 114 comprises navigation controls 116 and media controls 118, which are, in use, displayed within the application window 104.

The navigation controls 116 are configured to enable a user to manipulate the virtual media package 106 in the virtual space afforded by the application window 104 of the GUI 102. The media controls 118 comprise options for playing media content associated with the virtual media package 106. The media controls 118 may take a number of forms, including that of the controls of a music player as will be described later.

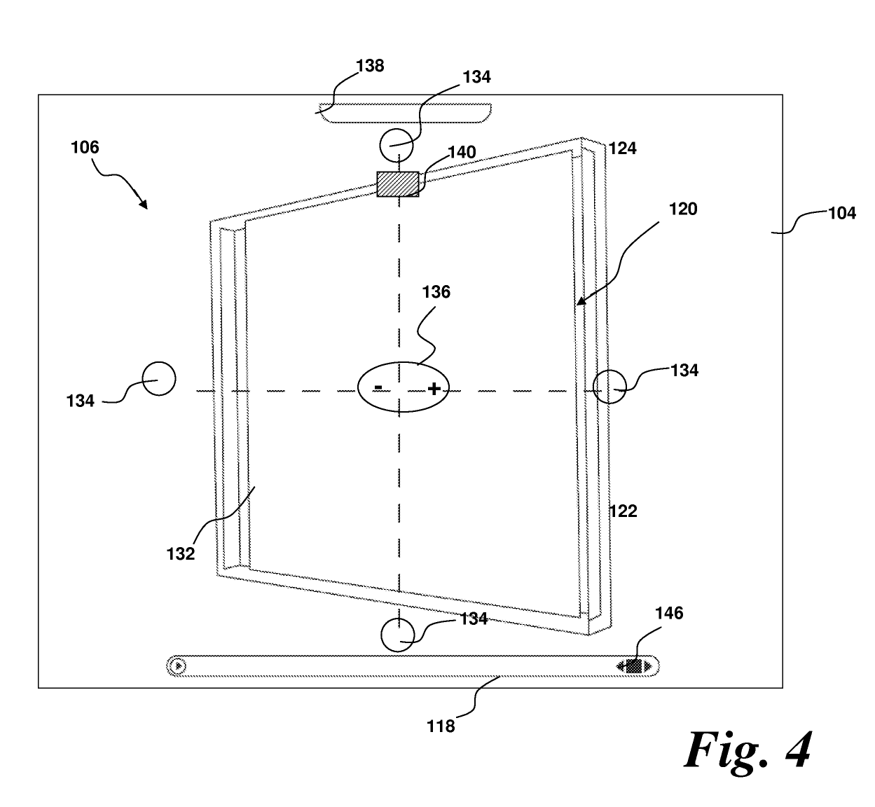

Referring now to FIGS. 3 and 4, a virtual media package 106 is shown within the application window 104. The package objects 108 of the virtual media package 106 comprise a 3D pixel or bitmap graphical representation of the physical CD product packaging; that is, in the present case, a CD case 120 as shown in FIGS. 3 and 4. However, other types of product packaging may be used; for example, record or tape packaging, digital video media packaging such as Digital Versatile Disc (DVD) boxes, or other such packaging.

The CD case 120 shown in FIGS. 3 and 4 is a dynamically-rendered 3D graphic built from bitmapped or pixel data. By this is meant that the images shown to the user are true 3D objects generated “on the fly” or dynamically and are not pre-rendered still images that are combined give the impression of a 3D object. The CD case 120 is rendered to appear “transparent” over the background of the application window 104, or any other backgrounds such as HTML backgrounds if the virtual media package 106 is displayed in, for example, an internet browser window.

The CD case 120 shown in FIGS. 3 and 4 is generally applicable to all CD-based media packaging and comprises a base 122 and a lid 124. The lid 124 may optionally be pivotable with respect to the base 122 in order to “open” the CD case 102 as is the case for a physical CD case.

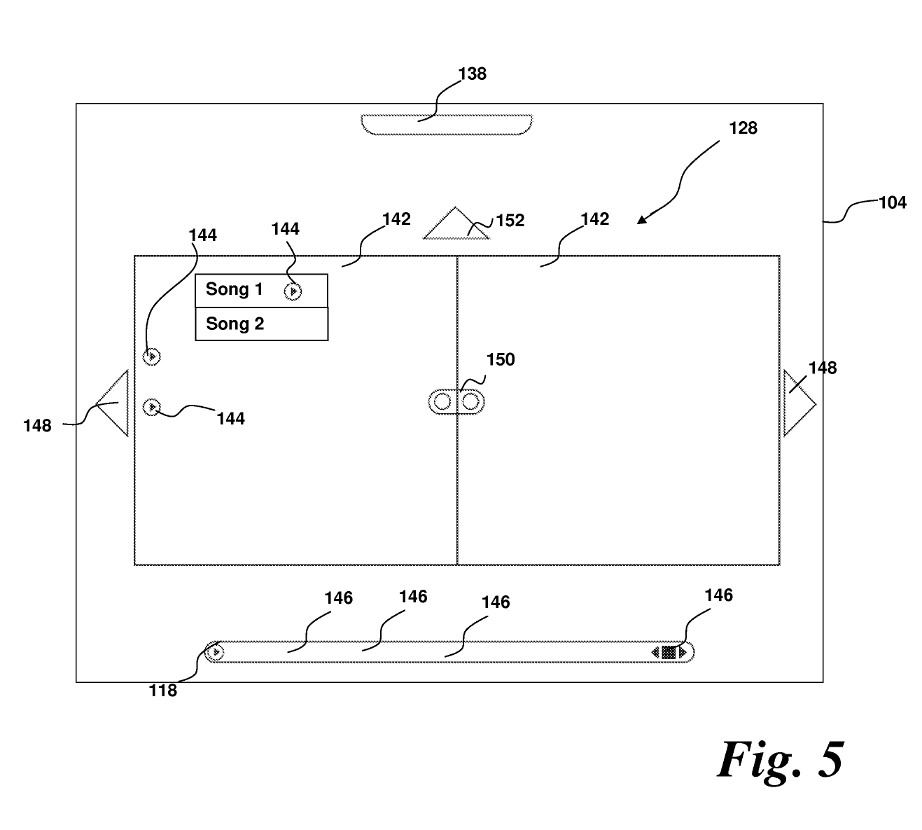

The content-specific objects 112 comprise, in this example, box artwork 126 and an inlay booklet 128 (see FIG. 5). The content-specific objects 112 comprise the graphics used to make up the unique “booklet” and the “tray inner” of the physical packaging of the CD case as represented by the virtual media package 106.

The box artwork 126 comprises a front cover 130 and a rear cover 132 (FIG. 4) that are positioned relative to, and moveable with respect to, the CD case 120 as would be the case for a physical CD case. That is, the box artwork 126 is itself a 3D image that is located inside the 3D image of the CD case 120. Therefore, the box artwork 126 is adjacent the front and back transparent surfaces such that the front and rear covers 130, 132 can be viewed through the lid 124 and base 122 respectively. The front and rear covers 130, 132 may comprise images in any suitable file format; for example, a bitmap file with a resolution appropriate to enable the detail of the front and rear covers 130, 132 to be viewed and read easily. For example, a bitmap with a resolution of about 600 x 600 pixels may be used.

A number of navigation controls 116 in the form of buttons are provided. The navigation controls 116 comprise rotation buttons 134 (see FIGS. 3 and 4), which enable rotation of the virtual media package 106 in the X and Y planes shown in FIG. 3. Alternatively, the x- and y-position and/or variation thereof of the mouse cursor may also be used as the controlling variables to enable the rotation of the virtual media package 106 in the application window 104. This may be done, for example, by holding down a mouse button and dragging the mouse in the desired direction to effect rotation of the virtual media package 106. Zoom buttons 136 are also provided to zoom into and out of the page along a Z axis.

A full screen button 138 is located at the upper end of the application window 104. The full screen button 138 is arranged to cause the application window 104 to fill the whole of the available screen space on a display of the computing device 12. This enables more detail or information to be displayed. A further selection of the full screen button 138 reduces the application window 104 back to a size that does not entirely fill the display of the computing device 12.

Additionally, an inlay button 140 is also provided. The inlay button 140, when operated, enables the inlay booklet 128 to be accessed, i.e. the view shown in FIG. 5 is enabled.

FIG. 5 shows an additional content-specific object in the form of the inlay booklet 128. The inlay booklet 128 is rendered as a separate 3D object and may comprise any number of pages 142. The pages 142 can be individually turned as will be described later. The booklet 128 is built dynamically from a variable number of pages 142 when it is loaded. The number of pages 142 is content-specific and will vary depending upon the number of pages in the actual inlay booklet that is being represented as part of the virtual media package 106.

Each page 142 of the inlay booklet 128 comprises a plurality of page graphics, each of which is stored on the media server 10 in both low resolution (e.g., 600×600 pixels) and high resolution (e.g., 1200×1200 pixels) format. The low resolution data is such that the booklet 128 can be viewed without zoom and be pleasing on the eye. The high resolution data of each page 134 is split into 6 horizontal strips (which, in this example, each comprise an image file of size 1200×200 pixels) and is sized to ensure the resulting image of maximum zoom is still pleasing on the eye and all small text can be read clearly.

The media-specific objects 112 comprise media links 144 to enable the user to play media content associated with the physical product, for example music tracks from the physical CD. The media links 144 of the media-specific objects 112 may define the page number within the booklet 128, the x- and y-positions of the media-specific objects 112 within the application window 104 and the URL definition or link to the media content file (for example, an MP3 file).

The links 144 are intended to be positioned relative to information about each track (for example, see “Song 1” or “Song 2” shown in FIG. 5). The media links 144 may link to MP3s that are either hosted locally by the client computer 12 or by the media server 10. The media links 144 may also comprise download links whereby media content is downloaded to the client computer 12, or alternatively may provide links to streaming media, i.e. media content that is consumed as it is retrieved from a remote server and that is not saved locally. Further, links may be provided that connect to, for example, the website of a particular band or music label. These links may be provided to enable the user to obtain further information (for example, tour dates, new releases or other information about the band or music label) relating to the media content and need not necessarily require the purchasing or consumption of media content.

The media links 144 may be transparent within the booklet 128 and be assigned a uniquely definable page number, X and Y position within the booklet 128 and have a particular URL link definition. They may be presented over “printed” URL links in the booklet to make them “live links.”

Optionally, when selected, the media links 144 may initiate operation of the media controls 118. If the media links 144 provide a link to actual media content for consumption by the user (e.g. MP3-type audio files), then the media controls 118 may comprise an audio player comprising multiple functions. These may comprise several audio buttons 146 including, for example, “play,” “stop,” “previous track,” and “next track” and volume control. The media controls 118 may also include a display showing, for example, the current artist and track information. This information may optionally be displayed without the inlay booklet 128 being visible. This is shown in FIGS. 3 and 4.

Alternatively, if no audio is pre-coded or stored on the client computer, the media server 10 or elsewhere, the media controls 118 may be configured to display a customizable message and function as a live link to a purchase point, or other relevant URL wherein the user can obtain the relevant media content. This may comprise providing a link to a website from where the media content could be purchased. In this case, the media link may launch an internet browser application, which is then directed to an appropriate retail website.

The functions of the media controls 118 can optionally be predetermined to become active or inactive on a given date or after a particular number of plays of the audio media. This enables “pay per view” or “pay per time period” (where the time period may be hours, days, weeks, months or the like), which controls when and for how long the media content may be available for. The predetermined time period may be used to control the visibility of all media controls 118 or media links 144 within the booklet 128.

Additionally, further media controls 118 may be provided to enable the user to access additional media content besides the CD packaging and the media itself Additional media controls 118 may optionally be provided to provide controls to enable the user to, for example, pre-order media content or to purchase merchandise or tickets for a live recital of the music author in question. These factors may all form part of the media-specific objects loaded from the media server 10 and active within the application program 100 and, consequently, displayed within the application window 104.

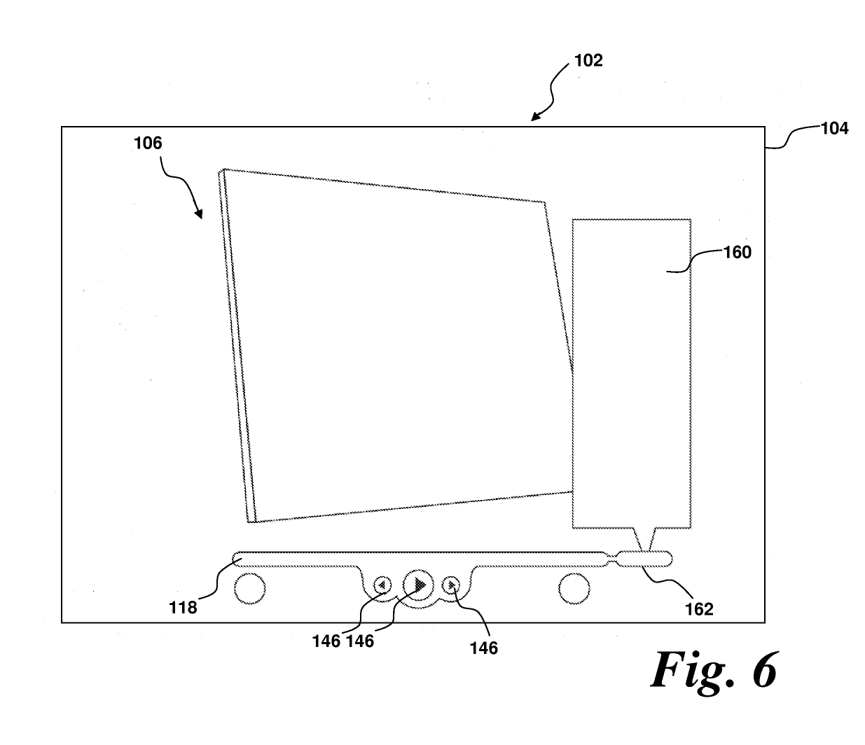

An example of this is shown in FIG. 6. FIG. 6 shows a view of the graphical user interface 102 running in an application window 104 and showing a view similar to that of FIGS. 3 and 4. Some features of the graphical user interface 102 and application window 104 shown in earlier figures have been omitted for clarity.

In FIG. 6, a virtual media package 106 is shown which, in common with the examples shown in FIGS. 3 and 4, comprises a dynamically-rendered and interactive, 3D graphical representation of a CD package and associated content. However, this example is also applicable to the application example using the inlay booklet 128 as the content-specific object in the application window 104.

In the example of FIG. 6, further media control features are provided in the form of a sign-up sheet 160. The sign-up sheet 160 may be provided in the form of a data entry box accessed from the media controls 118 through an additional icon 162. The sign-up sheet 160 may be accessed by selecting the icon 162, or by locating a cursor or mouse pointer or other selection device over the icon 162.

The sign-up sheet 160 may comprise purchase controls or data entry columns to enable a user to purchase merchandise, tickets or other products associated with the CD package and content shown in the application window 104. It may also provide the user with the opportunity to supply further data, such as a name, address for correspondence, email address or telephone number. This information may then be stored locally or transmitted to, for example, the vendor associated with the media content.

When the inlay booklet 128 is displayed (as shown in FIG. 5), further navigation controls 116 may become available. These take the form of next/previous page controls 148 and zoom functions 150, which enable the user to view the pages of the booklet. The buttons 148, 150 are interactive and dynamically made available relative to the graphics and/or page of the booklet 128 currently being viewed. The next/previous page buttons 148 enable navigation through the pages of the booklet 128. The zoom buttons 150 (represented in FIG. 5 as ‘+’ and ‘−’ buttons) control the zoom in and out of the pages of the booklet 128. Also provided is a close button 152, which returns the booklet 128 to a closed state and graphically returns the booklet 128 into the CD case 120. When the booklet is closed the booklet navigation buttons 148, 150, 152 may be made invisible and the view reverts back to a view as shown in FIGS. 3 and 4.

When the user selects the inlay button 140 to open the inlay booklet 128, content-specific objects 110 are required to be loaded. This is because data such as the pages of the inlay booklet 128 are stored on the media server 10 and may need to be downloaded. Once downloaded, the content-specific objects 110 may also be stored locally (for example, on a local hard disk drive or flash drive) so that the whole media experience can be enjoyed even without access to a network connection.

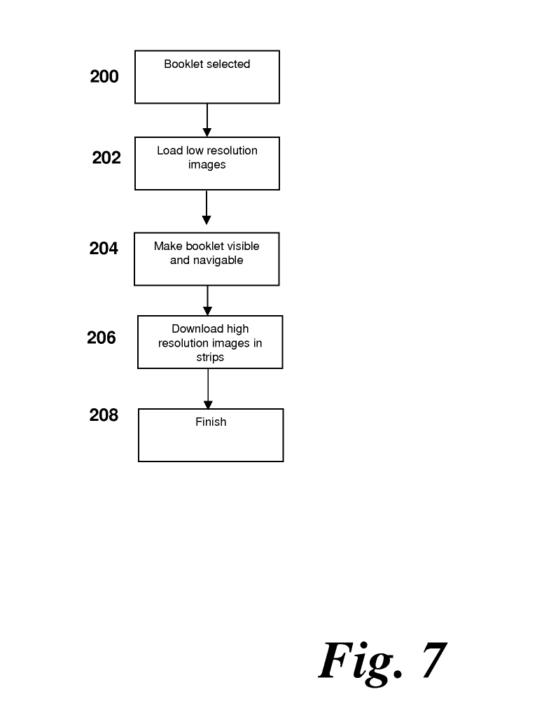

The method for loading the inlay booklet 128 will now be described with reference to FIG. 7.

At step 200, a booklet is selected when the user selects the inlay button 140 from the virtual media package display screen (as shown in FIGS. 3 and 4). This initialized the display of the inlay booklet 128. The method now proceeds to step 202

At step 202, low resolution images are loaded. The application program 100 is coded to load initially all of the low resolution pages. These pages are of a resolution of about 600 x 600 pixels. At the same time, a progress bar (not shown) graphically represents the download progress of the low resolution images. As described, these images may be downloaded from the media server 10 or may be retrieved from a local storage resource such as a hard drive forming part of the computing device 12. At this stage, the booklet remains invisible.

As the low resolution image of each page is loaded, each page is dynamically placed in order and dynamically given a z index with respect to the position of the respective page within the booklet 128. The method now proceeds to step 204.

At step 204, the booklet is made visible and navigable. Once all low resolution data representing each page of the booklet 128 is loaded, the booklet 128 can then be made visible. At this stage, the booklet 128 is also made fully navigable by use of the navigation buttons 144, 146, which enable the booklet 128 to be zoomed into/zoomed out of and for each page to be turned. The method now proceeds to step 206

At step 206, high-resolution images are downloaded in strips. Once the booklet 128 is visible, the high resolution page images are downloaded (or, alternatively, loaded from the local storage resource if the images have already been downloaded). Given the relatively large size of these images, each page is loaded in a series of strips. Each strip is then positioned relative to an assigned page in the booklet 128. At this point, a progress bar can be displayed that illustrates graphically the progress of downloading the high resolution images. This provides a seamless transition while the images are loading, which is pleasing to the user. The method then proceeds to step 208.

At step 208 the entire booklet 128 has been downloaded and is now represented in high resolution. The user can then view each page of the booklet 128 at a resolution whereby the text and detailed graphics of the booklet 128 can be reviewed easily.

However, alternative procedures may be used to load the data comprising the booklet 128. For example, the high resolution images need not be imported or loaded in strips. Once the booklet 128 is visible, the high resolution page images may be downloaded (or, alternatively, loaded from the local storage resource if the images have already been downloaded) as a single file for each page. Each page is then placed in the assigned position within the booklet 128.

The progress bar could still be displayed illustrating graphically the progress of downloading the individual high resolution images of each page of the booklet 128.

The above-described embodiments relate to an application program 100 that comprises a graphical user interface (GUI) 102 having an application window 104 on the display of a computing device. Within the application window 104, a physical media package such as a CD case is represented by a virtual media package 106. Each virtual media package 106 has associated content-specific objects 110 and media-specific objects 112 associated with a particular media content, for example a particular album by a particular artist.

However, a user may own a number of different albums, songs or associated media content. Therefore, it is desirable to provide a higher-level interface through which the user can select particular content from a plurality of different contents. A collection of media contents (such as, for example, albums, videos or singles) may be referred to as a content library.

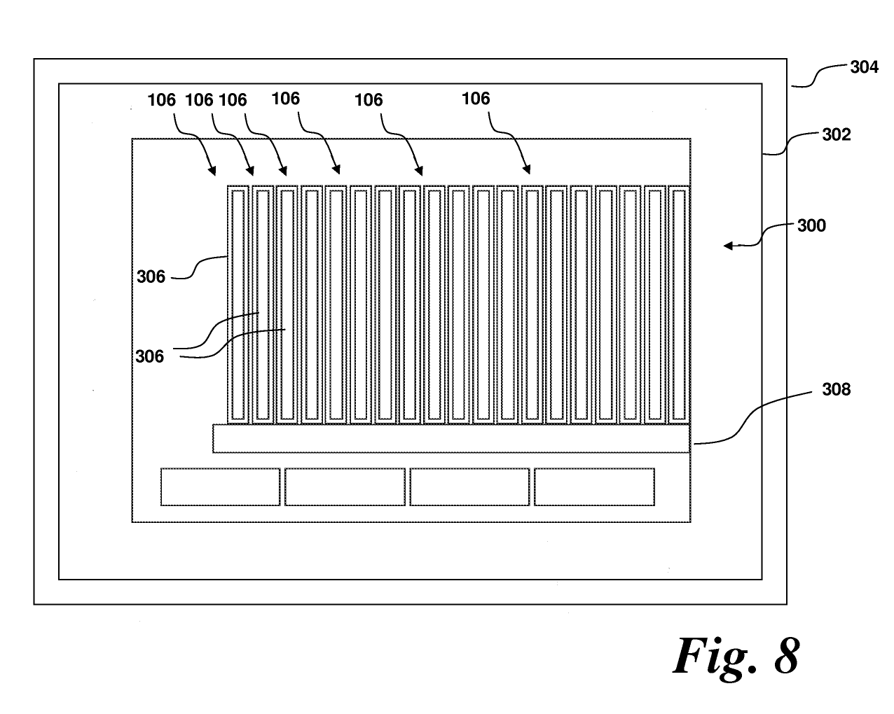

Consequently, it is useful to provide a higher-level interface displaying the user's content library through which the user may select a desired album, video, song or other content. An example of an interface for displaying such a content library is shown in FIG. 8.

FIG. 8 shows a content library 300 displayed in an application window 302 of a graphical user interface 304. The graphical user interface 304 form's part of an application program. The graphical user interface 304 may be the same as the graphical user interface 102 as described earlier and may form part of the application program 100 used to display the virtual media package 106 described previously.

Alternatively, the graphical user interface 304 may be separate from the graphical user interface 102 and may form part of a different application program from the application program 100 described previously. For example, the application program may comprise an additional add-on program or plug-in. Alternatively, the application program may comprise a standalone program on a computing device such as a smartphone.

The content library 300 comprises an interface providing access to a plurality of virtual media packages 106, with each virtual media package 106 having specific content related to that particular virtual media package 106. The interface comprises a display of the spines 306 of each virtual media package 106 in the library. A “shelf” 308 is provided to create the image of the virtual media packages 106 located on a virtual shelf or storage area as may be the case for a physical media package such as a CD.

Each virtual media package 106 displayed in the library may be thought of as an icon or link to the functions and content as described previously. For example, a particular virtual media package 106 may be chosen by selecting the spine 308 thereof. Then, if the application program running the content library 300 is different from the application program 100 for displaying the virtual media package 106, the selection may start the application program 100 to display the virtual media package 106 as described previously.

In the alternative, if the application program 100 is used to display the content library 300, then the selection may merely change the view seen by the user from the content library 300 to link to the individual selected virtual media package 106 as described in the examples above.

Additional features may be provided. In order to aid selection of the spine 306 of a particular virtual media package 106 on the shelf 308, an animation may be provided to indicate the selected (or about-to-be-selected) spine 306. For example, the spine 306 may appear to move out of the screen towards the user in the manner in which a physical CD may be removed from a shelf.

Additionally, the shelf 308 may be scrollable; that is, the display may move the shelf 308 along through the application window 304 such that off-screen content can be brought on-screen. This may be achieved through application functions or buttons (not shown) in the application window 304, or may be done automatically by moving a cursor, mouse pointer or other selection device close to the edge of the application window 304.

The content library 300 may additionally comprise search facilities such as keyword or content search to enable rapid location of particular media content. The content library 300 may, in addition, purely comprise a visual “front-end” to a more comprehensive database system for storing the user's local or online media content.

Variations of the above embodiments will be apparent to the skilled person. The precise configuration of hardware and software components may differ and still fall within the scope of the present disclosure.

For example, while the above examples have been shown and described with reference to a media server and client computing devices as described above, this need not be so. Any suitable arrangement of servers and client computing devices could be used.

Alternatively, the media content may be downloaded from a media store but subsequent consumption of the media content may be done offline. Therefore, there may be provided a facility to download the application program 100 (if it is not stored locally) so that the application program 100 can be run when the computing device 12 is not connected to a network.

Further, the option to download the various objects forming the virtual representation of the physical media package may be incorporated so that the whole media experience may be enjoyed by a user when the computing device 12 is offline.

As a further alternative, the user may already own a copy of a CD that they wish to “virtualize” and place on their digital collection. In this regard, there may be provided the facility to retrieve media content from a local source (such as a CD drive), which is then linked to downloaded material representing the virtual representation of the physical CD packaging. The virtual representation of the physical CD packaging may be downloaded from the media server. The downloaded content representing the physical CD packaging may then be stored locally for subsequent retrieval. This may be beneficial for a user in situations where no network connection is available. As described with reference to FIG. 1, in this situation a local storage resource then functions as the “media store.”

Additionally, the application program 100 (either with or without the content library functions) may be downloaded and run as a standalone application for review, selection and purchase of new media content. In the circumstance that the user does not own a particular media content such as a song or album, the media links may be arranged to enable short clips of the media content to be played prior to purchase by the user. However, as an alternative, the application program 100 may be configured to review the local or online content already owned by the user, and enable the already-owned content to be played in full, while displaying, for example, the album artwork and inlay cards. This provides the user with an additional dimension of utility to the existing content already owned by the user.

Embodiments of the present disclosure have been described with particular reference to the examples illustrated. While specific examples are shown in the drawings and are herein described in detail, it should be understood, however, that the drawings and detailed description are not intended to limit the disclosure to the particular form disclosed. It will be appreciated that variations and modifications may be made to the examples described within the scope of the present disclosure.

1. A method of providing access to media content and a virtual representation of physical packaging associated with said media content, the method comprising:
providing, on a display of a computing device, a virtual representation of a physical media package, said virtual representation comprising at least one dynamically-rendered three-dimensional object;
providing, on the computing device, navigational controls to enable a user to dynamically manipulate said virtual representation; and
providing, on the computing device, media controls to enable said user to select said media content associated with said physical media package.

2. The method according to claim 1, wherein said navigational controls enable said virtual representation to be rotated or translated in at least one dimension.

3. The method according to claim 1, wherein said virtual representation comprises packaging objects and content-specific objects.

4. The method according to claim 3, wherein said packaging objects are common for each virtual representation of a physical media package and said content-specific objects are specific to each virtual representation of a physical media package.

5. The method according to claim 3, wherein said packaging objects comprise a three-dimensional virtual representation of a Compact Disc case.

6. The method according to claim 3, wherein said content-specific objects comprise front and back cover graphics of said physical media package and/or an inlay booklet.

7. (canceled)

8. The method according to claim 6, wherein said content-specific objects comprise at least an inlay booklet and media controls are associated with said inlay booklet.

9. The method according to claim 1, wherein said media controls comprise media links to audio tracks comprising said media content and said media controls further comprise audio functions to enable a user to play said audio tracks.

10. (canceled)

11. The method according to claim 9, wherein said media links comprise links to enable a user to stream said media content to said computing device from a media store or to download said media content to said computing device from a media store or said media links comprise links to enable a user to purchase said media content from a media store.

12-16. (canceled)

17. The method according to claim 1, wherein said media controls are associated with said virtual representation.

18. A computing device for providing access to media content and a virtual representation of physical packaging associated with said media content, the computing device comprising:
a display; and
a processor to:
provide, on said display, a virtual representation of a physical media package, said virtual representation comprising at least one dynamically-rendered three-dimensional object;
provide navigational controls to enable a user to dynamically manipulate said virtual representation; and
provide media controls to enable said user to select said media content associated with said physical media package.

19-23. (canceled)

24. The computing device according to claim 18, wherein said media controls comprise media links to audio tracks comprising said media content and said media controls further comprise audio functions to enable a user to play said audio tracks.

25. (canceled)

26. The computing device according to claim 18, wherein said media links comprise links to enable a user to stream said media content to said computing device from a media store or to download said media content to said computing device from a media store, or said media links comprise links to enable a user to purchase said media content from a media store.

27. (canceled)

28. (canceled)

29. The computing device according to of claim 18, wherein said media controls are associated with said virtual representation.

30. (canceled)

31. A non-transitory computer usable storage medium having a computer program product stored thereon executable by a programmable processing apparatus to perform the steps of claim 1.

32. A graphical user interface generated by an application program operating on a computing device and operable to provide access to media content and a virtual representation of physical packaging associated with said media content, said graphical user interface configured to:
display a virtual representation of a physical media package as at least one dynamically-rendered three-dimensional object;
provide navigational controls to enable a user to dynamically manipulate said virtual representation;
provide media controls to enable said user to select media content associated with said physical media package.

33. The graphical user interface according to claim 32, wherein said navigational controls enable said virtual representation to be rotated or translated in at least one dimension.

34. The graphical user interface according to claim 32, wherein said virtual representation comprises packaging objects and content-specific objects.

35. The graphical user interface according to claim 34, wherein said packaging objects comprise a three-dimensional virtual representation of a compact disc case.

36. The graphical user interface according to claim 34, wherein said content-specific objects comprise front and back cover graphics of said physical media package and/or an inlay booklet.

37. (canceled)

38. The graphical user interface according to claim 32, wherein said media controls comprise media links to audio tracks comprising said media content and said media controls further comprise audio functions to enable a user to play said audio tracks.

39. (canceled)

40. The graphical user interface according to claim 38, wherein said media links comprise links to enable a user to stream said media content to said computing device from a media store or to download said media content to said computing device from a media store.

41-45. (canceled)

46. A method of providing access to a media store comprising a virtual representation of physical packaging associated with media content, the method comprising:
providing, on a display of a computing device, a virtual representation of the physical packaging associated with specific media content, said virtual representation comprising at least one dynamically-rendered three-dimensional object; and
providing, on the computing device, navigational controls to enable a user to dynamically manipulate said virtual representation.

47. The method according to claim 46, wherein said physical packaging comprises a Compact Disc case and said specific media content comprises audio tracks.

48. The method according to claim 47, wherein said physical packaging further comprises front and back cover artwork and/or an inlay booklet.

49. The method according to claim 46, wherein said media store comprises a networked media store or a storage resource local to said computing device.

50-53. (canceled)

54. A graphical user interface generated by an application program operating on a computing device and operable to provide access to a media store comprising a virtual representation of physical packaging associated with media content, said graphical user interface configured to:
display a virtual representation of physical packaging associated with specific media content as at least one dynamically-rendered three-dimensional object; and
provide navigational controls to enable a user to dynamically manipulate said virtual representation.

55. The graphical user interface according to claim 54, wherein said physical packaging comprises a Compact Disc case and said specific media content comprises audio tracks.

56. The graphical user interface according to claim 54, wherein said physical packaging further comprises front and back cover artwork and/or an inlay booklet.

57. (canceled)
